(19) United States
(12) Patent Application Publication
(10) Pub. No.: US 2026/0084079 A1
(43) Pub. Date: Mar. 26, 2026

(54) APPARATUS AND METHOD FOR FLUID TREATMENT OF A FEED COMPRISING A FLUID MIXTURE

(71) Applicant: RJ Enterprises Inc., Delta (CA)

(72) Inventor: Roderick M. Facey, Edmonton (CA)

(21) Appl. No.: 18/894,968

(22) Filed: Sep. 24, 2024

(51) Int. Cl. B01D 19/00; B01D 5/00; C02F 1/00; C02F 1/20; C02F 101/10; C02F 101/32; C02F 103/10

(52) U.S. Cl. CPC B01D 19/0047; B01D 5/0069; B01D 19/0005; B01D 19/0063; B01D 19/0068; C02F 1/008; C02F 1/20; C02F 2101/101; C02F 2101/322; C02F 2101/40; C02F 2103/10; C02F 2209/03; C02F 2209/42; C02F 2303/02

(57) ABSTRACT

An apparatus for fluid treatment of a feed comprising a fluid mixture including water and gas. The apparatus may comprise a phase separator, a gas-liquid separator, a vacuum source, a pressure sensor, a pressure controller, a flow restrictor, and a flow rate controller connected to send control signals to the flow restrictor to vary a flow rate of a purge gas. A method of fluid treatment of a feed comprising a fluid mixture including water and gas. The method may comprise mixing the feed in a mixing chamber, supplying the fluid into a gas-liquid separator, controlling a fluid pressure within the gas-liquid separator, a vacuum source to control a vacuum pressure within a headspace of the gas-liquid separator, and introducing purge gas into the mixing chamber through a purge gas inlet at a controlled flow rate.

### TECHNICAL FIELD

Phase separation technology. Specifically, phase separation technology for use in separating gases from a liquid medium.

### BACKGROUND

It is required in various industries to remove toxic, noxious, odorous or otherwise undesirable gases from a liquid medium. The liquid medium is typically oily water or wastewater. The toxic gases are typically hydrogen sulfide or volatile organic compounds (VOCs), mercaptans, and biogas.

To remove the gases, it is known to use a single separator with a separation chamber. The separator includes a centrifuge separator to enhance the separation process.

There is typically included a diffuser to provide flow into the separator, an oil weir, a water weir, or flow stabilization vanes. These single vessel separators are used to cause direct mixing of all fluids to achieve effective separation.

There may also be various chemical processes used to separate the toxic or odor causing gases from the liquid medium. Other methods include partial combustion processes or the use of a catalyst. Some of these methods may be expensive and may cause environmental impacts because of disposal and other considerations.

### SUMMARY

In an exemplary embodiment there is an apparatus for fluid treatment of a feed comprising a fluid mixture including water and gas. The apparatus may comprise a phase separator comprising a mixing chamber having a feed inlet and a mixing outlet, the mixing chamber having a length and an internal diameter, and a ratio of the length to the internal diameter of the mixing chamber being at least 20:1, and the feed inlet including a nozzle forming a restriction arranged to introduce turbulence to fluid within the mixing chamber. The apparatus may comprise a gas-liquid separator connected to receive a mixture exiting the mixing outlet through a mixture inlet, the gas-liquid separator having a fluid outlet and a gas outlet, a vacuum source downstream of the gas outlet, a pressure sensor between the mixture inlet and the vacuum source, and a pressure controller connected to send control signals to the vacuum source in response to signals from the pressure sensor to control a vacuum pressure within a headspace of the gas-liquid separator.

In various embodiments, there may be included one or more of the following features: the vacuum source is a vacuum pump; a heater upstream of the feed inlet; the phase separator further comprises a purge gas inlet for introducing purge gas into the mixing chamber, and the apparatus further comprising: a flow restrictor upstream of the purge gas inlet; and a flow rate controller connected to send control signals to the flow restrictor to vary a flow rate of purge gas through the purge gas inlet; a two-phase separator connected downstream of the fluid outlet of the gas-liquid separator, the two-phase separator comprising a chamber having a fluid inlet, an upper outlet and a lower outlet, the lower outlet being below the upper outlet and the upper outlet further comprising a weir, and the fluid inlet further comprising a diffuser; a pump downstream of the fluid outlet of the gas-liquid separator; a level controller connected to send signals to the pump to maintain a liquid level within the gas-liquid separator; a cooler connected downstream of the gas outlet; and a separator connected downstream of the cooler to condense recoverable liquids from gas exiting the gas outlet.

In an exemplary embodiment there is a method of fluid treatment of a feed comprising a fluid mixture including water and gas. The method may comprise mixing the feed in a mixing chamber of a phase separator, the mixing chamber having a feed inlet and a mixing outlet, the mixing chamber having a length and an internal diameter, and a ratio of the length to the internal diameter of the mixing chamber being at least 20:1, and the feed inlet including a nozzle forming a restriction arranged to introduce turbulence to fluid within the mixing chamber; supplying the fluid exiting from the mixing outlet of the mixing chamber into a gas-liquid separator having a mixture inlet, a fluid outlet and a gas outlet; and controlling a fluid pressure within the gas-liquid separator by sending control signals to a vacuum source downstream of the gas outlet to control a vacuum pressure within a headspace of the gas-liquid separator.

In various embodiments, there may be included any one or more of the following features: heating the feed prior to introducing the feed into the mixing chamber; introducing purge gas into the mixing chamber at a controlled flow rate; the flow rate is controlled using a flow restrictor upstream of the purge gas inlet and using a flow rate controller connected to send control signals to the flow restrictor to vary the controller flow rate of purge gas through the purge gas inlet; treating the fluid exiting the fluid outlet of the gas-liquid separator using a two-phase separator connected downstream of the fluid outlet of the gas-liquid separator, the two-phase separator comprising a chamber having a fluid inlet, an upper outlet and a lower outlet, the lower outlet being below the upper outlet and the upper outlet further comprising a weir, and the fluid inlet further comprising a diffuser; controlling a liquid level within the gas-liquid separator using a pump downstream of the fluid outlet; cooling gas downstream of the gas outlet to form cooled gas and condensing recoverable liquids from the cooled gas in a separator.

In one exemplary embodiment there is an apparatus for fluid treatment of a feed comprising a fluid mixture containing water and gas. The apparatus may comprise a phase separator comprising a mixing chamber having a feed inlet, a purge gas inlet and a mixing outlet, the mixing chamber having a length and an internal diameter, and a ratio of the length to the internal diameter of the mixing chamber being at least 20:1, and the feed inlet including a nozzle forming a restriction arranged to introduce turbulence to fluid within the mixing chamber; a gas-liquid separator connected to receive the feed exiting the mixing outlet through a mixture inlet, the gas-liquid separator having a fluid outlet and a gas outlet; and a flow restrictor upstream of the purge gas inlet, and a flow rate controller connected to send control signals to the flow restrictor to vary a flow rate of purge gas through the purge gas inlet.

In various embodiments, there may be included any one or more of the following features: a vacuum source downstream of the gas outlet; a pressure sensor between the mixture inlet and the vacuum source; and a pressure controller connected to send control signals to the vacuum source in response to signals from the pressure sensor to control a vacuum pressure within a headspace of the gas-liquid separator; a two-phase separator connected downstream of the fluid outlet of the gas-liquid separator, the two-phase separator comprising a chamber having a fluid inlet, an upper outlet and a lower outlet, the lower outlet being below the upper outlet and the upper outlet further comprising a weir, and the fluid inlet further comprising a diffuser; the vacuum source is a vacuum pump; a heater upstream of the feed inlet; a pump downstream of the fluid outlet; a level controller connected to send signals to the pump to maintain a liquid level within the gas-liquid separator; a cooler connected downstream of the gas outlet; and a separator connected downstream of the cooler to condense recoverable liquids from gas exiting the gas outlet.

In one exemplary embodiment there is a method of fluid treatment of a feed comprising a fluid mixture containing water and gas. The method may comprise supplying the feed into a mixing chamber of a phase separator, the mixing chamber having a feed inlet, a purge gas inlet and a mixing outlet, the mixing chamber having a length and an internal diameter, and a ratio of the length to the internal diameter of the mixing chamber being at least 20:1, and the feed inlet including a nozzle forming a restriction arranged to introduce turbulence to fluid within the mixing chamber; supplying the feed exiting the mixing chamber into a gas-liquid separator having a mixture inlet, a fluid outlet and a gas outlet; and introducing purge gas into the mixing chamber through the purge gas inlet at a controlled flow rate.

In various embodiments, there may be included any one or more of the following features: supplying the fluid exiting the fluid outlet of the gas-liquid separator into a two-phase separator connected downstream of the fluid outlet of the gas-liquid separator, the two-phase separator comprising a chamber having a fluid inlet, an upper outlet and a lower outlet, the lower outlet being below the upper outlet and the upper outlet further comprising a weir, and the fluid inlet further comprising a diffuser; controlling a fluid pressure within the gas-liquid separator by sending control signals to a vacuum source downstream of the gas outlet to control a vacuum pressure within a headspace of the gas-liquid separator; heating the feed prior to introducing the feed into the mixing chamber; the flow rate of the introduced purge gas is controlled using a flow restrictor upstream of the purge gas inlet and using a flow rate controller connected to send control signals to the flow restrictor to vary a flow rate of purge gas through the purge gas inlet; controlling a liquid level within the gas-liquid separator using a pump downstream of the fluid outlet; cooling gas downstream of the gas outlet to form cooled gas and condensing recoverable liquids from the cooled gas in a separator.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is schematic diagram of the apparatus for fluid treatment.

FIG. 2 is a flow chart of a method of fluid treatment.

FIG. 3 is a flow chart of a method of fluid treatment.

### DETAILED DESCRIPTION

The embodiments disclosed herein may be used in the separation and removal of toxic or odour causing gases, for example, hydrogen sulfide (H₂S), from a liquid medium. The liquid medium can be, for example, produced oily water, wastewater, or any other fluid mixture that contains as part of its compositional make-up water and the gas. The embodiments may be used in the separation and removal of H₂S and can also be used for the separation and removal of other toxic and odour causing gases. Examples of which include VOCs, mercaptans, and biogas. The use of the technology is not limited to the separation and recovery of H₂S. The embodiments provide the advantage of removing H₂S from a water containing mixture without the use or aid of chemicals. The embodiments disclosed herein may be used to separate other gases from liquids.

In alternative approaches, separators can be designed as a three-phase separator where gas is separated from a liquid miscible fluid mixture containing two or more liquid miscible fluids, such as oil in water, where miscible fluid separation is achieved by gravitational forces aided with gas flotation, where the gas responsible for flotation is that gas inducted as a secondary fluid by the phase separator, from where it is mixed with the primary motive stream under extreme turbulent conditions, where depending of the operating pressure and secondary gas flow the phase separator can be operated to create cavitational conditions within the mix chamber of the phase separator to enhance miscible fluid separation by gas flotation within the separation vessel. The terms ‘mix chamber’ and ‘mixing chamber’ are used interchangeably herein.

In contrast to those approaches, embodiments disclosed herein may use multiple separation vessels arranged in series.

Embodiments described herein may be used in the applications involving the separation and removal of toxic and dangerous gases from a water containing mixture. The embodiments disclosed herein may be used in separation and recovery of toxic and hazardous gases, such as H₂S, from a liquid medium containing water without the use of costly chemicals and absorbents.

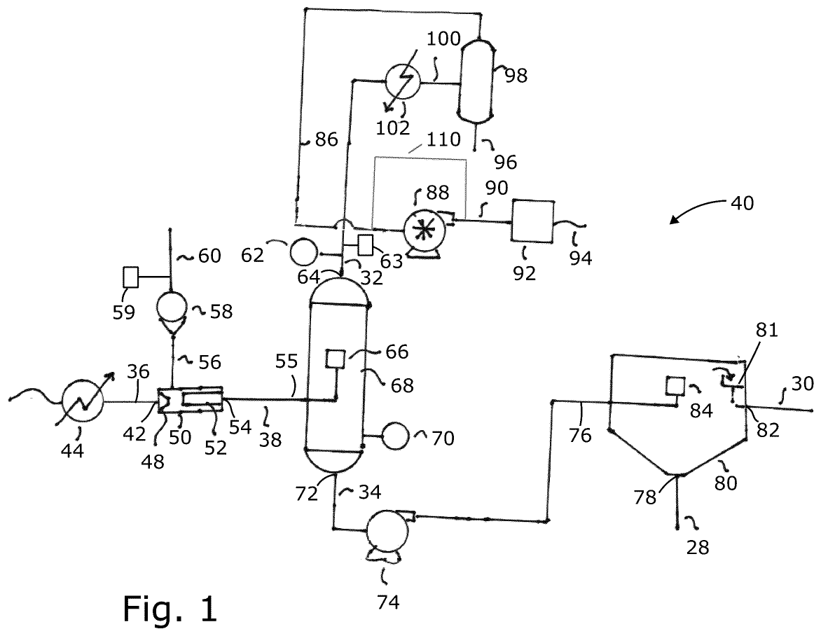

FIG. 1 shows an embodiment of an apparatus 40 for fluid treatment of a feed comprising a fluid mixture including water and gas. The apparatus 40 includes a phase separator 50. The phase separator 50 has a mixing chamber 52 having a feed inlet 42 and a mixing outlet 54. The phase separator 50 is the first separator in a series of separators, including a gas-liquid separator 68 and a two-phase separator 80.

The mixing chamber 52 of the phase separator 50 has a length and an internal diameter, and a ratio of the length to the internal diameter of the mixing chamber 52 may be at least 20:1. The mixing chamber 52 may have a length to internal diameter ratio of at least 40:1. In some embodiments, the length to internal diameter ratio may be in the range 50:1 to 60:1.

The feed inlet 42 may include a nozzle 48 forming a restriction arranged to introduce turbulence to fluid within the mixing chamber 52. The fluid within the feed inlet 42 may be referred to as the motive stream, and may comprise contaminated water containing a liquid medium that includes miscible fluids and dissolved toxic gases, such as H₂S. The nozzle 48 may be a jet nozzle arranged to induce mixing of the mixture with a gas.

The nozzle 48 may be a small diameter, short section of pipe where the diameter is chosen to convert the high volumetric fluid flow into a high velocity jet. Head loss associated with the nozzle 48 is limited to abrupt entrance and exit loss where the inlet is reduced to the nozzle inlet diameter without tapering, Similarly, the outlet discharges into a larger pipe without tapering. The nozzle 48 assists in converting a high volumetric flow into a high velocity jet stream to create the necessary turbulence and mixing in the mixing chamber 52, while resulting in a significant pressure drop to draw under suction the secondary gas flow for mixing with the motive stream within the mixing chamber 52. The nozzle 48 is not tapered, and is designed as a small diameter pipe with an abrupt inlet and outlet to simulate entrance and losses associated with a pipe flow flowing from the larger diameter pipe into the smaller diameter pipe with tapering between the two. The nozzle 48 may be made of hardened steel to minimize erosion damage. Other hard materials may also be used. The tip of the nozzle outlet has a circumferential groove that is slightly larger than the internal diameter of the nozzle 48 to reduce outlet wear damage to the nozzle.

The mixing chamber may be constructed with the following features:
a. Nozzle to Mix Chamber Spacing: Mix Chamber Internal Throat Diameter
   i. Minimum: 0.5 (spacing): 1 (mix chamber internal throat diameter)
   ii. Maximum: 2.0 (spacing): 1 (mix chamber internal throat diameter)
b. Mixing Chamber Length to Mix Chamber Internal Throat Diameter
   i. Minimum: 20 (mix chamber length): 1 (mix chamber internal throat diameter)
   ii. Maximum: 40 (mix chamber length): 1 (mix chamber internal throat diameter)
c. Required Pressure Drop Across Device: 85% of Inlet Pressure
d. Minimum Inlet Operating Pressure: 345 kPag (50 psig)
e. No Maximum Inlet Pressure Limit

As shown in FIG. 1, the mixing chamber 52 also has a purge gas inlet 56. Purge gas 60 may be introduced into the mixing chamber 52 where it is turbulently mixed with the feed inlet 42 stream where the purge gas 60 aids in the stripping of the toxic gas from the liquid stream as well as serves as the carrier gas to remove the toxic gases from the system. The phase separator 50 may be capable of converting a high volumetric flow into a high velocity jet stream required to induct the purge gas 60 under low pressure conditions. The creation of this high velocity jet stream creates a vacuum between the nozzle 48 and mixing chamber 52, that acts to induct a secondary flow of purge gas 60 into the phase separator 50 via the purge gas inlet 56. The purge gas can be natural gas, air, nitrogen, helium or any other inert gas. The pressure drop across the phase separator 50 can range from 50% to as high as 95% of the inlet pressure. The desired pressure drop can be varied by changing the nozzle 48 design and the dimensions of the mixing chamber 52.

In an embodiment, the feed within line 36, also referred to as the motive stream, which may be contaminated water containing liquid medium that includes miscible fluids, is first optionally heated, either directly or indirectly, to achieve the desired operating temperature of the process (<100° C.), from where the heated liquid medium enters the phase separator 50 where the volumetric flow is converted into a high velocity jet stream on passing through a non-tapered nozzle 48. To provide the desired heating, a heater 44 may optionally be provided upstream of the feed inlet 42 on line 36 to provide preheating of the feed inlet 42 to enhance the separation of the toxic gases. The feed within line 36 may flow into the heater 44, from where the stream is directly or indirectly heated. The heater 44 may be, for example, a direct heater, such as an electric heater. The heater 44 may be, for example, an indirect heater, such as a shell and tube exchanger where the heat medium can be hot water, glycol or thermal fluid. The feed within line 36 may be heated between a range of 60° C. to a maximum of 95° C. so as to not vaporize or flash the water fraction. The process may be capable of preheating a contaminated water containing liquid stream to a maximum temperature of 95° C. Other temperatures may be used that increase the temperature of the feed inlet 42 without vaporizing or flashing the water fraction.

As shown in FIG. 1, there is a flow restrictor 58 upstream of the purge gas inlet 56. The flow restrictor 58 can be automatically or manually adjusted to control the rate at which the purge gas 60 is inducted into the phase separator 50. The flow restrictor 58 may be capable of restricting the purge gas 60 flowrate into the phase separator 50 to cause extreme turbulent mixing together with cavitation within the mix chamber 52 of the phase separator 50. There may be a flow rate controller 59 connected to send control signals to the flow restrictor 58 to vary a flow rate of purge gas 60 through the purge gas inlet 56.

In some embodiments disclosed herein, control of the purge gas 60 flow rate provides various advantages. For example, a higher purge gas 60 flow rate, regardless of operating pressure, was found to increase H₂S removal.

The control of the purge gas 60 flow into the phase separator 50 can be used to modify the operating conditions within the phase separator 50. For example, restricting the purge gas 60 flow causes the phase separator 50 to operate under a vacuum. This may cause the fluid to cavitate during passage through the mixing chamber 52. The motive stream may be mixed with the purge gas 60 within the mixing chamber 52, such that the high pressure drop across the phase separator 50 results in extreme turbulent mixing. This extreme turbulent mixing creates a dynamic condition within the phase separator 50 where the purge gas bubble shape, size and concentration are continuously changing. The rate of purge flow will determine the degree of turbulent mixing that occurs within the phase separator 50. The lower the purge gas 60 flow, the higher the turbulent mixing, leading to cavitation within the mixing chamber 52.

From the phase separator 50, the gas-liquid stream flows through line 38 into a separation vessel, namely a gas-liquid separator 68. The gas-liquid separator 68 vessel may be configured to act as a vacuum degasifier. The gas-liquid separator 68 may be operated under reduced pressure, i.e. a vacuum, wherein the vacuum is produced using a vacuum source 88 that draws gas at a rate from the headspace of the gas-liquid 68 separator to create and maintain a vacuum between the range of zero pressure to full vacuum. Both elevated temperature and vacuum pressure, coupled with extreme turbulent mixing with a purge gas 60, separates the dissolved H₂S from the liquid phase. This off-gas together with the recovered purge gas 60 can be optionally treated using a wet chemical scavenger scrubbing process or an adsorbent media to remove the H₂S from the purge gas 60, following which the treated purge gas can be recycled for reuse.

The gas-liquid separator 68 is connected to receive the feed exiting the mixing outlet 54 and passing through line 38 into a mixture inlet 55 of the gas-liquid separator 68. The gas-liquid separator 68 includes a fluid outlet 72 and a gas outlet 64. In operation, the gas/liquid mixture flows from the mixing chamber 52 into the gas-liquid separator 68 via a mixing outlet 54. Upon entering the gas-liquid separator 68, the mixture flows out through a diffuser 66 into the separation vessel of the gas-liquid separator 68.

The vacuum source 88 is downstream of the gas outlet 64 and connected to the gas-liquid separator 68 by line 32. The vacuum source 88 may be a vacuum pump. The vacuum source 88 may vacuum the off-gas from a headspace of the gas-liquid separator 68, enabling the vessel to operate under vacuum conditions. There may be a pressure sensor 63 between the mixture inlet 55 and the vacuum source 88, for example, on line 32 as shown in FIG. 1. The pressure sensor 63 may be placed at other locations between the mixture inlet 55 and the vacuum source 88 to determine the vacuum pressure within the headspace of the gas-liquid separator 68. The vacuum source 88 may be controlled by a pressure controller 62 that draws both the off-gas and purge gas, where the off-gas contains the toxic gases, such as H₂S, under a vacuum via a gas outlet 64. The pressure controller 62 may be connected to send control signals to the vacuum source 88 in response to signals from the pressure sensor 63 to control the vacuum pressure within the headspace of the gas-liquid separator 68. The measured gas headspace pressure of the gas-liquid separator 68 may be used as the process variable via the pressure controller 62 to control the rotational speed of the vacuum source 88 so as to maintain a desired vacuum pressure within the headspace of the gas-liquid separator 68. The headspace vacuum pressure may be operator adjustable.

The vacuum source 88 may create vacuum conditions within the gas headspace of the gas-liquid separator 68, to vacuum degasify dissolved gases from the liquid fluid phase. The vacuum source 88 may be capable of evacuating the off-gas and purge gas 60 at a rate necessary to create vacuum conditions within the gas-liquid separator 68. The embodiments disclosed herein may enhance the amount and degree of removal of H₂S from the water containing liquid. Operating the gas-liquid separator 68 under a vacuum and increasing the operating temperature of the system provides the advantage of reducing the solubility of H₂S in the water phase without the use and aid of chemicals or absorbents. This provides a low-cost method that does not require the use of scavenger chemicals or absorbents. In addition to the removal of dissolved H₂S, operating the gas-liquid separator 68 under a vacuum may also reduce and remove from the liquid phase other dissolved gases such as oxygen and carbon dioxide.

There may be various advantages provided by the embodiments disclosed herein. For example, there may be improved removal efficiencies for dissolved H₂S from the liquid medium that includes a water fraction was measured to range from 95% by weight to as high as 99% by weight, achieving residual H₂S concentrations in the liquid phase of below 10 ppm at vacuum conditions ranging from zero pressure to full vacuum.

Vacuum degasification was found to be further expedited by using elevated temperature because some properties such as density, viscosity, and solubility become more favorable for removal and separation as the temperature of the fluid increases. For example, favourable operating conditions were measured to occur at temperatures greater than 80° C. Other operating temperatures may also be used.

The process includes a by-pass line 110, to allow the gas-liquid separator 68 to operate as a pressure vessel, allowing for the use of very high purge gas 60 flowrates. Desktop advanced process simulations have shown H₂S can be separated and recovered from a liquid phase, for example, under vacuum conditions (negative pressure) or alternatively at positive pressure under very high purge gas 60 flowrates, where the ratio of purge gas 60 to the liquid feed stream ranged from 10 (purge gas): 1 (liquid feed) to as high as 100 (purge gas): 1 (liquid feed). Operating the gas-liquid separator 68 under a positive pressure will allow the vacuum source 88 to be by-passed, whereby the purge gas 60 is fed to the phase separator at low pressure (<5 psig) so as to achieve the require purge gas 60 to liquid feed ratios.

From the vacuum source 88, the gas flows via line 90 into a gas treatment unit 92 which can be a chemical wet scrubber scavenger system or an adsorbent media. The gas treatment is designed to remove the toxic gas to allow the treated gas 94 to be recycled as a purge gas. Liquids that are condensed and recovered from cooling the gas stream 100 out of the gas-liquid separator 68 are discharged from the separator 98 via a line 96.

There may be a cooler 102 connected downstream of the gas outlet 64, and a separator 98 connected downstream of the cooler 102 to condense recoverable liquids from gas exiting the gas outlet 64. The cooler 102 and separator 98 may be designed to condense and drop out any condensable reducing the volumetric flow required to be transferred via the vacuum source 88. The gas may be indirectly cooled using the cooler 102, which is designed to cool the gas stream 100 to condense and drop out any recoverable liquids in the separator 98 reducing the volumetric flow that flows into the vacuum source 88 via a line 86. The cooler 102 may be, for example, an arial cooler designed to cool the gas to near ambient temperature. Other types of coolers and temperatures may be used that provide adequate cooling to condense the liquids.

The liquid fraction, comprised of miscible fluids, that remains following vacuum degasification, is recovered from the gas-liquid separator 68 via a fluid outlet 72 into line 34 using a pump 74 downstream of the fluid outlet 72 of the gas-liquid separator 68. A level controller 70 is connected to send signals to the pump 74 to maintain a liquid level within the gas-liquid separator 68. The pump 74 may be a positive displacement vacuum pump. The pump 74 may be used to transfer the residual liquid fraction under vacuum conditions to facilitate transfer of the liquid fraction when operating the gas-liquid separator 68 under a vacuum. Examples of positive displacement pumps include piston and plunger style pumps and vane, gear and diaphragm pumps or any other pumps that transfer liquids under vacuum suction pressure.

Control and operation of the pump 74 may be assisted by using a level transmitter sensor to measure the liquid level in the gas-liquid separator 68 that is then used as the process variable via the level controller 70 to control the rotational speed of the pump 74 so as to maintain a desired liquid level within the gas-liquid separator 68.

The pump 74 and vacuum source 88 may operate independently of each other via their own control systems and processors or be connected to the same control system and processor. In general, any of the controllers or processors described herein can be part of a single control system or may be separate control systems each with their own controllers, or a mixture of the different numbers of control systems. These systems can be operated manually by operator input or automatically based on detected conditions within the system, or a combination of the two, for example, with an operator being able to override the automatic operation of the system or to manually set or change parameters on which the system operates.

A two-phase separator 80 is connected downstream of the fluid outlet 72 of the gas-liquid separator 68. This two-phase separator operates as a third separator in series, and operates as a second separator vessel. There is an initial phase separator 50 which initially mixes the initial feed using highly turbulent flow, and the resulting mixture is fed into the two separator vessels, namely the gas-liquid separator 68 and the two-phase separator 80, with the processed fluids entering the vessels one after the other.

The two-phase separator 80 includes a chamber having a fluid inlet 76, an upper outlet 82 and a lower outlet 78, the lower outlet 78 being below the upper outlet 82. The upper outlet 82 may further comprise a weir 81, and the fluid inlet 76 further may further comprise a diffuser 84.

In operation, the remaining liquid phase is recovered and may be transferred to the two-phase separator 80 where gravitational forces are used to separate and recover the miscible fractions of the liquid phase. The two-phase separator 80 may be designed to separate light and heavy miscible liquid fractions under the forces of gravity, and in some embodiments, the two-phase separator 80 may be capable of separating and recovering the light and heavy miscible liquid fractions into separate streams using only gravitational forces.

The recovered liquid fraction flows via a fluid inlet 76 into the two-phase separator 80 vessel up through and out diffuser 84. The heavier miscible is recovered from the two-phase separator 80 via lower outlet 78 through line 28 while the lighter miscible fraction overflows the weir 81 and is recovered via the upper outlet 82 through line 30.

As discussed above, the gas-liquid separator 68 may be operated under vacuum (or positive pressure when vacuum source 88 is by-passed) conditions at elevated temperatures. The second separation vessel may follow in series and may operate as a two-phase separator 80 designed to gravitationally separate miscible fluids of different density.

Various process variables may be manipulated to impact the separation and recovery of H₂S or other target gasses from the liquid medium. For example, the variables that may be manipulated include purge gas flowrate, gas-liquid separator vacuum pressure, feed inlet fluid temperature, and pressure drop across the phase separator.

For example, high purge gas flowrate at low to moderate vacuum pressures, where the purge gas rate was 10 times the feed rate, produced favourable results where the H₂S concentration in the treated liquid medium was typically below 10 ppm for an initial feed concentration of 1000 ppm. Similarly, at low purge gas flowrates (<5 times the feed rate), at high to full vacuum pressures, produced similar favourable results reported for high purge gas flowrates. At very high purge gas flowrates (>50 times the liquid feed stream), similar H₂S removal rates may be achieved without the need to operate the system under vacuum conditions. However, at this high purge gas flowrate, a pressurized purge gas flow may be required to achieve the required flowrate.

In some embodiments, fluid pressure and purge gas flow rate may be varied independently of each other, and in some embodiments the system may be operated with a vacuum pressure within a headspace of the gas-liquid separator 68 without the induction of purge gas 60 and in other embodiments the system may be operated with controlled purge gas flow rate without separately controlled vacuum pressure within a headspace of the gas-liquid separator 68. Other variables of the system may similarly be varied or omitted entirely so long as sufficient recovery of target gases from the feed is achieved.

Lines as disclosed herein may be any type of fluid connection, such as a pipe, or other device that allows for the transfer of fluid.

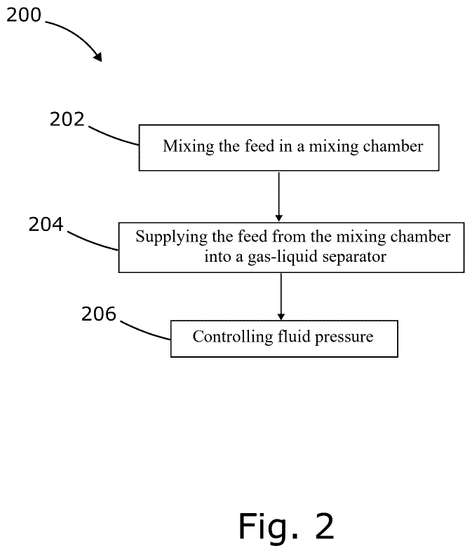

As shown in FIG. 2, there is an embodiment of a method 200 of fluid treatment of a feed comprising a fluid mixture including water and gas. At 202, the feed is mixed in a mixing chamber of a phase separator. The mixing chamber 52 may have a feed inlet 42 and a mixing outlet 54. The mixing chamber 52 may have a length and an internal diameter, and a ratio of the length to the internal diameter of the mixing chamber 52 being at least 20:1. The feed inlet 42 may include a nozzle 48 forming a restriction arranged to introduce turbulence to fluid within the mixing chamber 52. At 204, the fluid exiting from the mixing outlet 54 of the mixing chamber 52 is supplied into a gas-liquid separator 68 having a mixture inlet 55, a fluid outlet 72 and a gas outlet 64. At 206, a fluid pressure within the gas-liquid separator 68 is controlled by sending control signals to a vacuum source 88 downstream of the gas outlet 64 to control a vacuum pressure within a headspace of the gas-liquid separator 68.

In various embodiments, there may be included one or more of the following features: heating the feed prior to introducing the feed into the mixing chamber 52; introducing purge gas 60 into the mixing chamber 52 at a controlled flow rate, wherein the flow rate is controlled using a flow restrictor 58 upstream of the purge gas inlet 56 and using a flow rate controller 59 connected to send control signals to the flow restrictor 58 to vary the controller flow rate of purge gas 60 through the purge gas inlet 56; treating the fluid exiting the fluid outlet 72 of the gas-liquid separator 68 using a two-phase separator 80 connected downstream of the fluid outlet 72 of the gas-liquid separator 68, the two-phase separator 80 comprising a chamber having a fluid inlet 76, an upper outlet 82 and a lower outlet 78, the lower outlet 78 being below the upper outlet 82 and the upper outlet 82 further comprising a weir 81, and the fluid inlet 76 further comprising a diffuser 84; controlling a liquid level within the gas-liquid separator 68 using a pump 74 downstream of the fluid outlet 72; cooling gas downstream of the gas outlet 64 to form cooled gas and condensing recoverable liquids from the cooled gas in a separator 98.

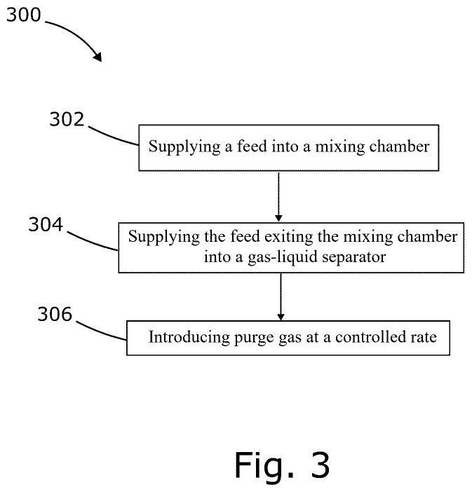

As shown in FIG. 3, there is an embodiment of a method 300 of fluid treatment of a feed comprising a fluid mixture containing water and gas. At 302 the feed is supplied into a mixing chamber 52 of a phase separator 50. The mixing chamber 52 may have a feed inlet 42, a purge gas inlet 56 and a mixing outlet 54. The mixing chamber 52 may have a length and an internal diameter, and a ratio of the length to the internal diameter of the mixing chamber 52 being at least 20:1. The feed inlet 42 may include a nozzle 48 forming a restriction arranged to introduce turbulence to fluid within the mixing chamber 52. At 304, the feed exiting the mixing chamber 52 is supplied into a gas-liquid separator 68 having a mixture inlet 55, a fluid outlet 72 and a gas outlet 64. At 306, purge gas 60 is introduced into the mixing chamber 52 through the purge gas inlet 56 at a controlled flow rate.

In various embodiments, there may be included one or more of the following features: supplying the fluid exiting the fluid outlet 72 of the gas-liquid separator 68 into a two-phase separator 80 connected downstream of the fluid outlet 72 of the gas-liquid separator 68, the two-phase separator 80 comprising a chamber having a fluid inlet 76, an upper outlet 82 and a lower outlet 78, the lower outlet 78 being below the upper outlet 82 and the upper outlet 82 further comprising a weir 81, and the fluid inlet 76 further comprising a diffuser 84; controlling a fluid pressure within the gas-liquid separator 68 by sending control signals to a vacuum source 88 downstream of the gas outlet 64 to control a vacuum pressure within a headspace of the gas-liquid separator 68; heating the feed prior to introducing the feed into the mixing chamber 52; the flow rate of the introduced purge gas 60 is controlled using a flow restrictor 58 upstream of the purge gas inlet 56 and using a flow rate controller 59 connected to send control signals to the flow restrictor 58 to vary a flow rate of purge gas 60 through the purge gas inlet 56; controlling a liquid level within the gas-liquid separator 68 using a pump 74 downstream of the fluid outlet 72; cooling gas downstream of the gas outlet 64 to form cooled gas and condensing recoverable liquids from the cooled gas in a separator 98.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. An apparatus for fluid treatment of a feed comprising a fluid mixture including water and gas, the apparatus comprising:
a phase separator comprising a mixing chamber having a feed inlet and a mixing outlet, the mixing chamber having a length and an internal diameter, and a ratio of the length to the internal diameter of the mixing chamber being at least 20:1, and the feed inlet including a nozzle forming a restriction arranged to introduce turbulence to fluid within the mixing chamber;
a gas-liquid separator connected to receive a mixture exiting the mixing outlet through a mixture inlet, the gas-liquid separator having a fluid outlet and a gas outlet;
a vacuum source downstream of the gas outlet;
a pressure sensor between the mixture inlet and the vacuum source; and
a pressure controller connected to send control signals to the vacuum source in response to signals from the pressure sensor to control a vacuum pressure within a headspace of the gas-liquid separator.

2. The apparatus of claim 1 in which the vacuum source is a vacuum pump.

3. The apparatus of claim 1 further comprising a heater upstream of the feed inlet.

4. The apparatus of claim 1 in which the phase separator further comprises a purge gas inlet for introducing purge gas into the mixing chamber, and the apparatus further comprising:
a flow restrictor upstream of the purge gas inlet; and
a flow rate controller connected to send control signals to the flow restrictor to vary a flow rate of purge gas through the purge gas inlet.

5. The apparatus of claim 1 further comprising:
a two-phase separator connected downstream of the fluid outlet of the gas-liquid separator, the two-phase separator comprising a chamber having a fluid inlet, an upper outlet and a lower outlet, the lower outlet being below the upper outlet and the upper outlet further comprising a weir, and the fluid inlet further comprising a diffuser.

6. The apparatus of claim 1 further comprising:
a pump downstream of the fluid outlet of the gas-liquid separator;
a level controller connected to send signals to the pump to maintain a liquid level within the gas-liquid separator.

7. The apparatus of claim 1 further comprising:
a cooler connected downstream of the gas outlet; and
a separator connected downstream of the cooler to condense recoverable liquids from gas exiting the gas outlet.

8. A method of fluid treatment of a feed comprising a fluid mixture including water and gas, the method comprising:
mixing the feed in a mixing chamber of a phase separator, the mixing chamber having a feed inlet and a mixing outlet, the mixing chamber having a length and an internal diameter, and a ratio of the length to the internal diameter of the mixing chamber being at least 20:1, and the feed inlet including a nozzle forming a restriction arranged to introduce turbulence to fluid within the mixing chamber
supplying the fluid exiting from the mixing outlet of the mixing chamber into a gas-liquid separator having a mixture inlet, a fluid outlet and a gas outlet; and
controlling a fluid pressure within the gas-liquid separator by sending control signals to a vacuum source downstream of the gas outlet to control a vacuum pressure within a headspace of the gas-liquid separator.

9. The method of claim 8 further comprising heating the feed prior to introducing the feed into the mixing chamber.

10. The method of claim 8 further comprising introducing purge gas into the mixing chamber at a controlled flow rate.

11. The method of claim 10 in which the flow rate is controlled using a flow restrictor upstream of the purge gas inlet and using a flow rate controller connected to send control signals to the flow restrictor to vary the controller flow rate of purge gas through the purge gas inlet.

12. The method of claim 8 further comprising treating the fluid exiting the fluid outlet of the gas-liquid separator using a two-phase separator connected downstream of the fluid outlet of the gas-liquid separator, the two-phase separator comprising a chamber having a fluid inlet, an upper outlet and a lower outlet, the lower outlet being below the upper outlet and the upper outlet further comprising a weir, and the fluid inlet further comprising a diffuser.

13. The method of claim 8 further comprising controlling a liquid level within the gas-liquid separator using a pump downstream of the fluid outlet.

14. The method of claim 8 further comprising cooling gas downstream of the gas outlet to form cooled gas and condensing recoverable liquids from the cooled gas in a separator.

15. An apparatus for fluid treatment of a feed comprising a fluid mixture containing water and gas, the apparatus comprising:
a phase separator comprising a mixing chamber having a feed inlet, a purge gas inlet and a mixing outlet, the mixing chamber having a length and an internal diameter, and a ratio of the length to the internal diameter of the mixing chamber being at least 20:1, and the feed inlet including a nozzle forming a restriction arranged to introduce turbulence to fluid within the mixing chamber;
a gas-liquid separator connected to receive the feed exiting the mixing outlet through a mixture inlet, the gas-liquid separator having a fluid outlet and a gas outlet; and
a flow restrictor upstream of the purge gas inlet, and a flow rate controller connected to send control signals to the flow restrictor to vary a flow rate of purge gas through the purge gas inlet.

16. The apparatus of claim 15 further comprising:
a vacuum source downstream of the gas outlet;
a pressure sensor between the mixture inlet and the vacuum source; and
a pressure controller connected to send control signals to the vacuum source in response to signals from the pressure sensor to control a vacuum pressure within a headspace of the gas-liquid separator.

17. The apparatus of claim 15 further comprising:
a two-phase separator connected downstream of the fluid outlet of the gas-liquid separator, the two-phase separator comprising a chamber having a fluid inlet, an upper outlet and a lower outlet, the lower outlet being below the upper outlet and the upper outlet further comprising a weir, and the fluid inlet further comprising a diffuser.

18. The apparatus of claim 16 in which the vacuum source is a vacuum pump.

19. The apparatus of claim 15 further comprising a heater upstream of the feed inlet.

20. The apparatus of claim 15 further comprising:
a pump downstream of the fluid outlet;
a level controller connected to send signals to the pump to maintain a liquid level within the gas-liquid separator.

21. The apparatus of claim 15 further comprising:
a cooler connected downstream of the gas outlet; and
a separator connected downstream of the cooler to condense recoverable liquids from gas exiting the gas outlet.

22. A method of fluid treatment of a feed comprising a fluid mixture containing water and gas, the method comprising:
supplying the feed into a mixing chamber of a phase separator, the mixing chamber having a feed inlet, a purge gas inlet and a mixing outlet, the mixing chamber having a length and an internal diameter, and a ratio of the length to the internal diameter of the mixing chamber being at least 20:1, and the feed inlet including a nozzle forming a restriction arranged to introduce turbulence to fluid within the mixing chamber;
supplying the feed exiting the mixing chamber into a gas-liquid separator having a mixture inlet, a fluid outlet and a gas outlet; and
introducing purge gas into the mixing chamber through the purge gas inlet at a controlled flow rate.

23. The method of claim 22 further comprising:
supplying the fluid exiting the fluid outlet of the gas-liquid separator into a two-phase separator connected downstream of the fluid outlet of the gas-liquid separator, the two-phase separator comprising a chamber having a fluid inlet, an upper outlet and a lower outlet, the lower outlet being below the upper outlet and the upper outlet further comprising a weir, and the fluid inlet further comprising a diffuser.

24. The method of claim 22 further comprising:
controlling a fluid pressure within the gas-liquid separator by sending control signals to a vacuum source downstream of the gas outlet to control a vacuum pressure within a headspace of the gas-liquid separator.

25. The method of claim 22 further comprising heating the feed prior to introducing the feed into the mixing chamber.

26. The method of claim 24 in which the flow rate of the introduced purge gas is controlled using a flow restrictor upstream of the purge gas inlet and using a flow rate controller connected to send control signals to the flow restrictor to vary a flow rate of purge gas through the purge gas inlet.

27. The method of claim 22 further comprising controlling a liquid level within the gas-liquid separator using a pump downstream of the fluid outlet.

28. The method of claim 22 further comprising cooling gas downstream of the gas outlet to form cooled gas and condensing recoverable liquids from the cooled gas in a separator.
